(19) United States
(12) Patent Application Publication
(10) Pub. No.: US 2018/0324072 A1
(43) Pub. Date: Nov. 8, 2018

(54) INFORMATION TECHNOLOGY ANALYTICS

(71) Applicant: ENTIT SOFTWARE LLC, SANFORD, NC (US)

(72) Inventors: Cameron Michael Prymak, Kanata (CA); Andrei Pancu, Kanata (CA)

(21) Appl. No.: 15/771,037

(22) PCT Filed: Oct. 30, 2015
(86) PCT No.: PCT/US2015/058391

§ 371 Date: Apr. 25, 2018

(51) Int. Cl. H04L 12/26; G06Q 30/02

(52) U.S. Cl. CPC H04L 43/0876; H04L 43/04; H04L 43/065; G06Q 30/0204

(57) ABSTRACT

Disclosed are techniques for analyzing Information Technology (IT) trends. An example computing device includes a memory to store computer-readable instructions and a processor to execute the computer-readable instructions. The computer-readable instructions include a data collector to collect component usage data corresponding to a plurality of Information Technology (IT) components coupled to networks of a plurality of organizations, wherein the plurality of IT components comprise different types of IT components. The computer-readable instructions include an IT analytics module to analyze the component usage data to generate aggregated usage data corresponding to at least one of the different types of IT components and the plurality of organizations. The computer-readable instructions include a report generator to generate a report that includes at least a portion of the aggregated usage data and send the report to the user.

### BACKGROUND

Today's large enterprises are increasingly dependent on Information Technology (IT) infrastructure. Customers of IT face challenges ensuring that the products they purchase are the correct fit for their technical specifications and may often rely on information provided by IT Manufacturers.

### BRIEF DESCRIPTION OF THE DRAWINGS

Certain examples are described in the following detailed description and in reference to the drawings, in which:

FIG. 1 is a diagram of a server network coupled to a vendor relationship manager according to some examples;

FIG. 2 is a block diagram of a vendor relationship manager coupled to a plurality of enterprise networks according to some examples;

FIG. 3 is an example report that can be generated by the vendor relationship manager according to some examples;

FIG. 4 is a process flow diagram summarizing a method of collecting and processing IT component usage data according to some examples; and

FIG. 5 is a block diagram showing a non-transitory, machine-readable medium that stores code to provide a virtual machine migration manager according to some examples.

### DETAILED DESCRIPTION

This disclosure describes, for example, techniques to provide visibility into IT utilization trends across market segments. As stated above, customers of IT face challenges ensuring that the products they purchase are the correct fit for their technical specifications and may rely on information provided by vendors. However, such vendor provided information may be perceived to be biased or may be unintentionally outdated. This disclosure presents example methods to speed up sharing of relevant peer-group IT experiences by using an asset management solution to report and analyze customer installed IT components. By sharing this information in a secure environment, customers may vet industry claims and narrow down their potential IT solutions more quickly and at lower costs.

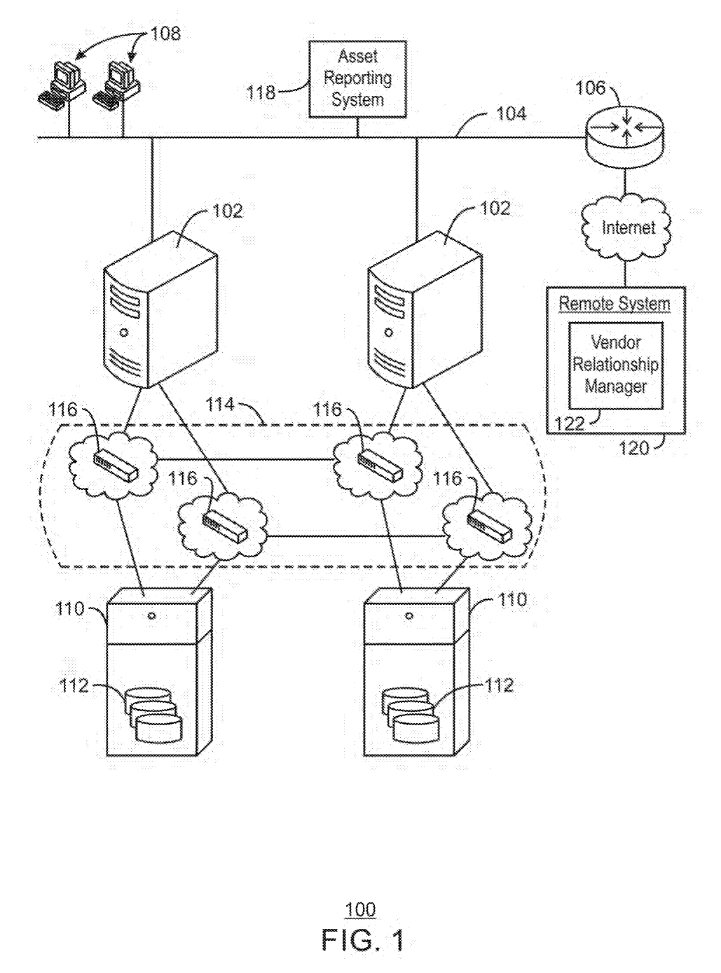

FIG. 1 is a diagram of a server network coupled to a vendor relationship manager according to some examples. The enterprise network 100 is a computer network owned and operated by an enterprise such as a company, non-profit organization, educational institution, or government agency, for example. The enterprise network 100 may, for example, be a single data center, or may include multiple geographically dispersed data centers.

The enterprise network 100 may include a number of servers 102 operatively coupled by a communications network 104, for example, a wide area network (WAN), local area network (LAN), virtual private network (VPN), the Internet, and the like. The communications network 104 may be a TCP/IP protocol network or any other appropriate protocol. The enterprise network 100 can also include routers 106 coupled to the communications network 104, to enable communication with other networks such as the internet.

Any number of client systems 108 may access the servers 102 through the communications network 104. Each server 102 may host software applications that are accessible to the client systems 108. In some examples, the servers 102 may host virtual machines, each of which can provide an operating system instance to a client systems 108.

Each data center 102 may also include data storage systems 110. Each data storage system 110 includes a plurality of storage devices 112, such as hard disks, solid state drives, or other type of storage medium. The client systems 108 may access the data storage systems 110 through the servers 102. The servers 102 may access the data storage systems 110 through a storage area network 114, which may include a plurality switches 116 to route traffic between the servers 102 and the data storage systems 110. The storage area network 114 can use any suitable communication protocol to access the data storage systems 110, including Ethernet, Fibre Channel, SCSI (Small computer System Interface), Fibre Channel over Ethernet (FCoE), and Fibre Channel over IP (FCIP), among others.

Also included in the enterprise network 100 may be the asset reporting system 118. In some examples, the asset reporting system 118 is to report data about the enterprise network 100 to a remote system. The data reported by the asset reporting system 118 is referred to herein as “component usage data.” The component usage data can include any information that describes characteristics of the enterprise network, such as the types of components used in the enterprise network, the quantity and manufacturer model of components, and the configuration and usage of those components. The component usage data can be obtained automatically by an asset manager that collects information about devices connected to a network and can be used by IT professionals to document their internal networks. In some examples, the asset reporting system 118 is implemented as a plug-in for existing asset manager software.

In some examples, the asset reporting system 118 can access a Configuration Management Database (CMDB) 120, which includes a repository of information representing a configuration of the components of the enterprise network 100. The CMDB 120 can be used to store the relationships between network components and track their configuration and performance. The asset reporting system 118 can query the configuration management database to obtain information about the infrastructure state of the enterprise network 100.

The data reported by the asset reporting system 118 may include configuration, performance, and capacity information about any aspect of the enterprise network and its components. For example, the asset reporting system 118 may report the number, type, and configuration of the switches 116 and/or routers 106. With regard to the servers 102, the asset reporting system 118 may report identifying information such as model, manufacturer, number and type of processors, number of processor cores, the software being hosted by the server, whether the server is a rack mounted server or blade server, and others. With regard to the data storage systems 110, the asset reporting system 118 may report model, manufacturer, storage capacity, type of storage medium, RAID configuration, replication configuration, the amount of useable and raw storage capacities for storage area networks, network attached storage and direct attached storage, and others.

The asset reporting system 118 can also report user generated data. For example, the user may rate their satisfaction with various IT components of the enterprise network 100. The user generated data can also include an identification of the market segment in which the operator of the enterprise network resides. For example, the asset reporting system 118 may report that enterprise network 100 is operated by a particular type of manufacturing company, non-profit organization, government organization, university, and others. Each market segment may be further divided at various levels of specificity. For example, the manufacturing category may be further divided into different types of manufacturers.

The asset reporting system 118 reports all of the collected data to a remote system 120, which hosts an application referred herein as the vendor relationship manager 122. The vendor relationship manager 122 may be a Web based application, such as a Web (Application Programming Interface). Before sending any of the component usage data to the remote system 120, the asset reporting system anonymizes the data, by removing any information from the data that might identify the operator of the enterprise network 100, security information, or any the sensitive data, such as Media Access Control (MAC) addresses, or Internet Protocol (IP) addresses of components.

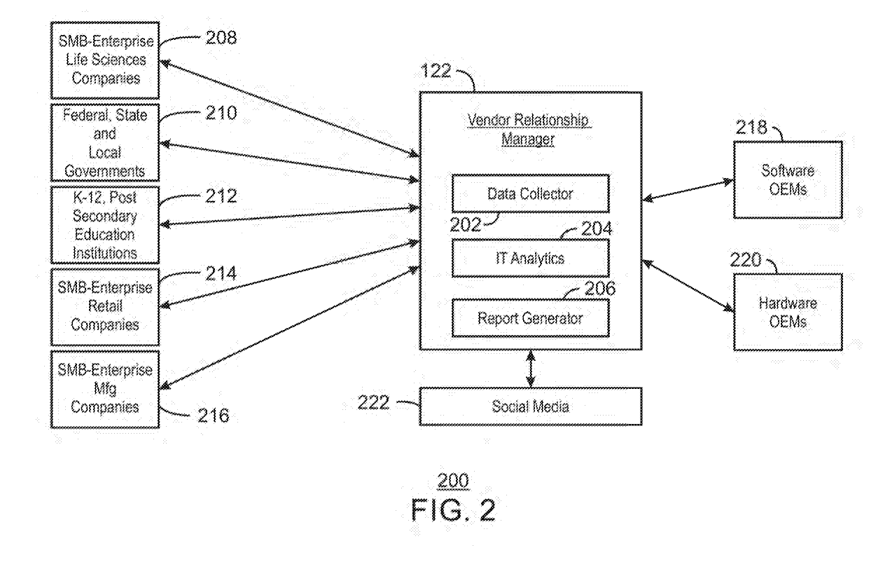

The vendor relationship manager 122 analyzes the component usage data to generate aggregated usage data that is applicable to a plurality of organizations. The aggregated usage data can be used to identify trends in the IT world, which can be organized according to market segment. The vendor relationship manager 122 can generate reports, which can be sent to an administrator or other user of the enterprise network 100. The reports may be generated by the vendor relationship manager 122 in response to a query received from the computer network 100. Features of the vendor relationship manager 122 are described further in relation to FIG. 2.

The configuration of the enterprise network 100 is but an example of a network may be implemented in accordance with the present techniques. In some examples, the described enterprise network 100 may be modified based on design considerations for a particular system. For example, a server network 100 in accordance with examples of the present disclosure may include any suitable number of servers 102 and any suitable number of data storage systems 110.

FIG. 2 is a block diagram of a vendor relationship manager coupled to a plurality of enterprise networks according to some examples. Each of the enterprise networks may be arranged in a similar fashion to what was described in FIG. 1. However, it will be appreciated that each enterprise network will be expected to include different types of components and configurations.

As shown in FIG. 2, the vendor relationship manager can include a data collector 202, an IT analytics module 204, and a report generator 206. The data collector 202 collects IT component usage data from the enterprise networks. Each of the enterprise networks may be included within one of several market segments 208 to 216. In the example shown in FIG. 2, market segment 208 represents life science companies, market segment 210 represents government agencies, market segment 212 represents educational institutions, market segment 214 represents retail companies, and market segment 216 represents manufacturing companies. It will be appreciated that the specific market segments represented in FIG. 2 are a small sample of the different types of market segments that could be represented.

Each of the enterprise networks within the different market segments includes some sort of asset reporting system, such as the asset reporting system 118 described in relation to FIG. 1. The asset reporting system can obtain data about the components within its network, anonymize the data and send the data to the data collector 202. Data may be gathered and sent to the data collector on a regular schedule, for example, daily or weekly. The schedule may be specified by an administrator of the enterprise network. Furthermore, in some examples, the data received by the data collector has been anonymized by the asset reporting system.

In some examples, the data collector 202 can anonymize the received data to remove any identifying information. The anonymization process performed by the data collector 202 may be performed in place of or in addition to the anonymization performed by the asset reporting system 118.

The IT analytics module 204 analyzes the collected data, which may be received from hundreds or thousands of different organizations. The IT analytics module 204 can group and organize the component usage data to generate aggregated component usage data corresponding the different types of IT components and the plurality of organizations. The data generated by the IT analytics module 204 can be grouped according to the different types IT components, the different industry segments, and the like.

In some examples, the data collector 202 also receives unstructured social media data from social media sources 222. The social media sources can be Web based social media services such as Facebook, Twitter, blogs, Rich Site Summary (RSS) feeds, and others. In some examples, the social media data is received by a Web crawling feature of the data collector 202. The IT analytics module 204 can process the social media data to generate rating information about various IT components. The rating information may indicate a level of positive or negative sentiment about the IT component in question. The rating information may be generated, for example, by a data mining feature of the IT analytics module 204.

The report generator 206 can receive the aggregated component usage data and generate reports. The reports may be sent to the various enterprises that provided the IT component data. The reports may provide actual customer usage information for assets purchased and installed. In this way, IT customers can acquire accurate, objective, and up-to-date information about the types of components and systems that are currently being used by other IT consumers. Additionally, the reports can be focused on a particular market segment, so that IT customers can see what types of IT components and systems are being adopted by their peers, which may be expected to have similar IT needs.

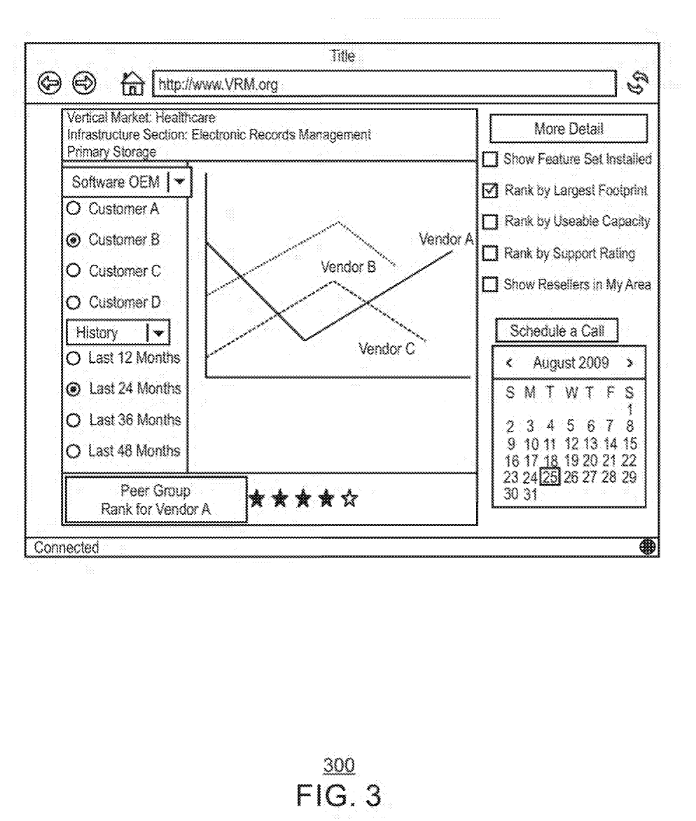

Reports may also be sent to other IT component vendors and Original Equipment Manufacturers (OEMs), such as software OEMs 218 and the hardware OEMs 220. Such reports would allow manufacturers to gain immediate feedback on their products' adoption rates. An example of a report is described in relation to FIG. 3.

FIG. 3 is an example report that can be generated by the vendor relationship manager according to some examples. As shown in FIG. 3, the report may be generated as an interactive Web page. The particular report shown in FIG. 3 is generated for a healthcare market segment, and more particularly for the electronic records management segment within healthcare. Furthermore, the report shows a graph that describes the storage capacity across the selected market segment and a selection of relevant hardware OEMs, described in the graph as Vendor A, Vendor 8, and Vendor C. Using this graph, another organization that provides electronic records management in the healthcare market can see what storage device vendors are being relied on to provide primary storage capacity for their market, and what the overall trends in storage capacity have been over a certain time frame. The Vendor Relationship Manager allows IT Customers to show interest or request a meeting with IT vendors with whom they may have no existing relationship.

The graph shown in FIG. 3, shows the primary storage footprint for each vendor, which enables the user to visualize the relative market share for each vendor and how the market shares have varied over time. Other types of graphs may be selected by the user, including graphs that describe the feature sets installed, usable storage capacity, support rating for each vendor, resellers for each vendor, and many other types of information. Any IT component usage information gathered from the enterprise networks may be represented in one of the reports.

Neither the source of the data, nor any aspect relevant to protecting the security of each data provider is revealed in the report. Users can sort data based on market segment or application, but no identifying data may be included, such as IP addresses, IT personnel names, and the like. The resulting analysis will show metrics like the top trending SAN in the Tier 1 Automotive Supplier market segment. However, no specific corporate source information will be shown. In some examples, IT customers can also share their support experiences and this information can be included in a report to provide a more comprehensive assessment.

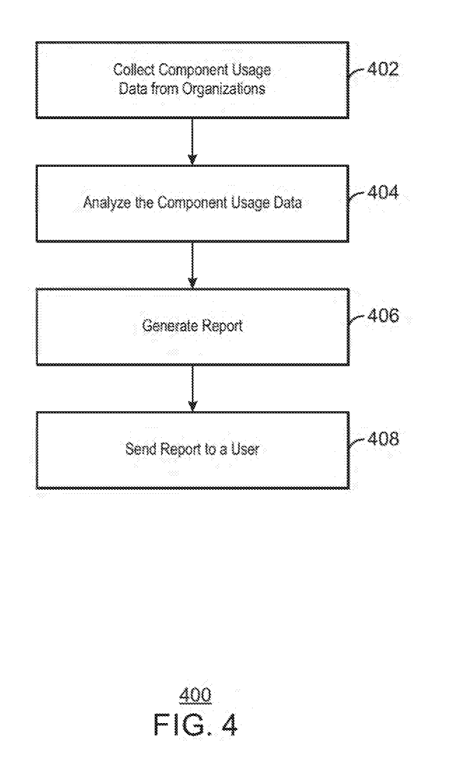

FIG. 4 is a process flow diagram summarizing a method of collecting and processing IT component usage data according to some examples. The method may be referred to by the reference number 400, and may be performed by the example system of FIG. 2.

The method begins at block 402, wherein component usage data is collected. The component usage data describes a plurality of Information Technology (IT) components, which are coupled to networks of a plurality of organizations. The plurality of IT components include different types of IT components such as switches, routers, servers, storage arrays, software components, among others. The component usage data can be collected by a Web-based application. The component usage data received may be fully or partially anonymized at the source network before it is received. Any identifying information still included in the component usage data may be eliminated after being received. The data may be collected periodically, for example, daily, weekly, or monthly. Social media data from IT customers public comments on their experiences is also analyzed and made available to provide IT customers with as a single source of hard data and trending sentiment around IT customer experiences.

At block 404, the usage data is analyzed to generate aggregated usage data. The aggregated usage data relates to at least one of the different types of IT components used throughout the plurality of organizations. For example, the aggregated usage data may describe some aspect of a particular type of storage as it relates to its usage within different organizations. In some examples, the analysis groups the component usage data according to market segments. For example, different data sets can be generated for different types of companies or industries. The aggregated usage data generated at block 404 may relate to one or several market segments.

At block 406, a report is generated. The report includes at least a portion of the aggregated usage data. The report can overlay to show a comprehensive view in real-time to provide a thorough comparison of buying experiences and trends. The report can include a portion of the aggregated usage data selected by a user. The report can display the usage data in any suitable format.

At block 408, the report is sent to a user. The user may be one of the organizations from which the usage data was collected, or another party such as an OEM. The report may be transferred to the user over the Internet as an HTML page, for example. An example of a report is shown in FIG. 3.

It is to be understood that the process flow diagram of FIG. 4 is not intended to indicate that the method is to include all of the blocks shown in FIG. 4 in every case. Further, any number of additional blocks can be included within the method, depending on the details of the specific implementation. In addition, it is to be understood that the process flow diagram of FIG. 4 is not intended to indicate that the method is to proceed in the order indicated by the blocks shown in FIG. 4 in every case.

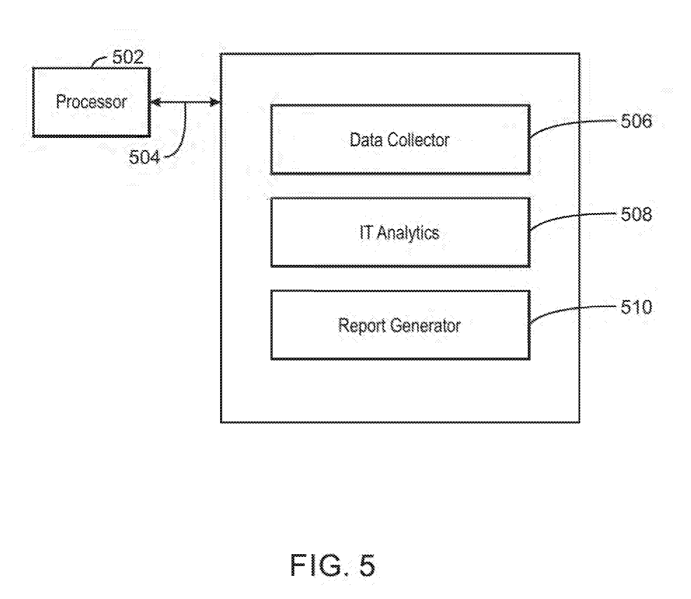

FIG. 5 is a block diagram showing a non-transitory, machine-readable medium that stores code to provide a virtual machine migration manager according to some examples. The non-transitory, machine-readable medium is referred to by the reference number 500. The non-transitory, machine-readable medium 500 can include RAM, a hard disk drive, an array of hard disk drives, an optical drive, an array of optical drives, a non-volatile memory, a universal serial bus (USB) drive, a digital versatile disk (DVD), a compact disk (CD), and the like. In examples, the non-transitory, machine-readable medium 500 is executed on servers in a server cluster. The non-transitory, machine-readable medium 500 may be accessed by a processor 502 over a communication path 504.

As shown in FIG. 5, the various components discussed herein can be stored on the non-transitory, machine-readable medium 500. A first region 506 can include a data collector to collect component usage data corresponding to a plurality of Information Technology (IT) components coupled to networks of a plurality of organizations, wherein the plurality of IT components include different types of IT components. A second region can include an IT analytics module to analyze the component usage data to generate aggregated usage data corresponding to at least one of the different types of IT components and the plurality of organizations. A third region can include a report generator to generate a report that includes at least a portion of the aggregated usage data and send the report to the user.

Although shown as contiguous blocks, the components can be stored in any order or configuration. For example, if the tangible, non-transitory, computer-readable medium is a hard drive, the components can be stored in non-contiguous, or even overlapping, sectors.

The examples described herein may be susceptible to various modifications and have been shown for illustrative purposes. Furthermore, it is to be understood that the present techniques are not intended to be limited to the particular examples disclosed herein. Indeed, the scope of the appended claims is deemed to include all modifications and equivalents that are apparent to persons skilled in the art to which the disclosed subject matter pertains.

What is claimed is:

1. A computing device, comprising:
a memory to store computer-readable instructions; and
a processor to execute the computer-readable instructions, wherein the computer-readable Instructions are to direct the processor to:
collect component usage data corresponding to a plurality of Information Technology (IT) components coupled to networks of a plurality of organizations, wherein the plurality of IT components comprise different types of IT components;
analyze the component usage data to generate aggregated usage data corresponding to at least one of the different types of IT components and the plurality of organizations; and
generate a report comprising at least a portion of the aggregated usage data and send the report to the user.

2. The computing device of claim 1, wherein the computer-readable instructions direct the processor to remove identifying information from the component usage data.

3. The computing device of claim 1, wherein the computer-readable instructions direct the processor to collect the component usage data daily.

4. The computing device of claim 1, wherein the computer-readable instructions direct the processor to group the aggregated usage data according to market segment.

5. The computing device of claim 1, wherein the computer-readable instructions direct the processor to generate an interface to provide the report to a manufacturer of one of the IT components.

6. A method, comprising:
collecting component usage data corresponding to a plurality of Information Technology (IT) components coupled to networks of a plurality of organizations, wherein the plurality of IT components comprise different types of IT components;
analyzing the component usage data to generate aggregated usage data corresponding to at least one of the different types of IT components and the plurality of organizations;
generating a report comprising at least a portion of the aggregated usage data; and
sending the report to a user.

7. The method of claim 6, comprising removing identifying information from the component usage data.

8. The method of claim 6, wherein collecting component usage data comprises the collecting the component usage data daily.

9. The method of claim 6, wherein analyzing the component usage data to generate aggregated usage data comprises aggregating the usage data according to market segment.

10. The method of claim 6, comprising sending the report to a manufacturer of one of the IT components.

11. A computer-readable medium comprising instructions that, when executed, direct a processor to:
collect component usage data corresponding to a plurality of Information Technology (IT) components coupled to networks of a plurality of organizations, wherein the plurality of IT components comprise different types of IT components;
analyze the component usage data to generate aggregated usage data corresponding to at least one of the different types of IT components and the plurality of organizations; and
generate a report comprising at least a portion of the aggregated usage data and send the report to the user.

12. The computing device of claim 11, wherein the computer-readable instructions direct the processor to remove identifying information from the component usage data.

13. The computing device of claim 11, wherein the component usage data is collected daily.

14. The computing device of claim 11, wherein the aggregated usage data is grouped according to market segment.

15. The computing device of claim 11, wherein the computer-readable instructions direct the processor to generate an interface to provide the report to a manufacturer of one of the IT components.
